(19) United States
(12) Patent Application Publication
(10) Pub. No.: US 2013/0288027 A1
(43) Pub. Date: Oct. 31, 2013

(54) MULTI-LAYER COMPOSITE

(71) Applicant: Gunter Richter, Wuppertal (DE)

(72) Inventor: Gunter Richter, Wuppertal (DE)

(73) Assignee: US Coatings IP Co. LLC, Wilmington, DE (US)

(21) Appl. No.: 13/996,736

(22) PCT Filed: Dec. 28, 2011
(86) PCT No.: PCT/US11/67528

§ 371 Date: Jun. 21, 2013

Related U.S. Application Data
(60) Provisional application No. 61/427,512, filed on Dec. 28, 2010.

(51) Int. Cl. G02B 5/20

(52) U.S. Cl. CPC G02B 5/208
USPC 428/212; 427/160

(57) ABSTRACT

A process for the production of a multi-layer composite, wherein a coating layer is applied from a pigmented coating composition onto the front face of an NIR-opaque foil exhibiting low NIR absorption, wherein the pigment content of the coating composition consists 50 to 100 wt. % of at least one black pigment with low NIR absorption and 0 to 50 wt. % of at least one further pigment, which is selected in such a way that the coating layer exhibits low NIR absorption and that the multi-layer composite has a color with a brightness L* of at most 10 units, wherein the sum of the wt. % equals 100 wt. %, and wherein the coating layer is cured.

### FIELD OF THE INVENTION

The invention is directed to a multi-layer composite comprising an NIR-opaque foil, the NIR-opaque foil having a front face and a back face, wherein the front face is provided with a coating. The invention is also directed to a process for the production of such multi-layer composite. The invention is furthermore directed to the use of the multi-layer composite, i.e. its application to the surface of a substrate.

### DESCRIPTION OF THE PRIOR ART

Dark-color coatings often contain carbon black pigments which absorb radiation in the near-infrared wavelength range and transform it into heat. Substrates coated with paint coatings of this type heat up in the NIR-containing sunlight; this occurs via heat conduction, i.e., heat is directly transferred to the substrate from the coating layer containing carbon black pigments and heated by solar radiation. This type of heating is often undesirable; for example, it may be undesirable for the actual substrate material itself and/or for the interior of the substrate to be heated up.

WO 2009/146317 A1, WO 2009/146318 A1, WO 2010/030970 A2 and WO 2010/030971 A2 disclose processes for the production of a multi-layer coating on a substrate, during which a substrate is provided with an NIR-opaque coating layer exhibiting low NIR absorption and subsequently with a dark-color coating layer exhibiting low NIR absorption. The substrates so provided with dark-color multi-layer coatings heat up only comparatively slightly in sunlight.

### SUMMARY OF THE INVENTION

The invention is directed to a multi-layer composite in the form of an NIR-opaque foil which has a pigmented coating on its front face. The multi-layer composite can be produced by a process comprising the successive steps:
(1) providing an NIR-opaque foil exhibiting low NIR absorption, and
(2) applying a coating layer from a pigmented coating composition onto the front face of the foil,
   wherein the pigment content of the coating composition consists 50 to 100 wt. % (weight-%) of at least one black pigment with low NIR absorption and 0 to 50 wt. % of at least one further pigment, which is selected in such a way that the coating layer exhibits low NIR absorption and that the multi-layer composite has a color with a brightness L* of at most 10 units,
   wherein the sum of the wt. % equals 100 wt. %, and
   wherein the coating layer is cured.

The invention is therefore also directed to the process for the production of the multi-layer composite.

### DETAILED DESCRIPTION OF THE EMBODIMENTS

The abbreviation “NIR” used herein stands for “near infrared” or “near infrared radiation” and shad mean infrared radiation in the wavelength range of 780 to 2100 nm.

The term “NIR-opaque foil” is used herein. It refers to a foil which when covering the surface of an underlying substrate provides for that underlying substrate surfaces (substrate surfaces located directly beneath the foil) with different NIR absorption are no longer discernible by NIR reflection measurement (no longer distinguishable from each other by NIR reflection measurement), i.e. no difference can be determined when measuring the NIR reflection of the foil covering such different substrate surfaces: or to put it into other words, the NIR reflection curve measured is then only determined by the NIR-opaque foil itself. NIR-opacity can be the result of NIR absorption and/or NIR reflection and/or NIR scattering. Whether a foil is NIR-opaque or not depends essentially on the composition of the foil and its thickness. In order to determine whether a foil exhibits said NIR-opacity it may be put or applied onto a black and white chart. Black and white charts are typically used when determining black/white opacity of coating compositions (see, for example, ISO 6504-3:2006 (E), method B).

NIR reflection measurement is known to the person skilled in the art and can be carried out making use of a conventional NIR spectrophotometer (measuring geometry 8°/d), for example, the instrument Lambda 19 sold by the firm Perkin-Elmer. NIR-opacity of an NIR-opaque foil can be the result of NIR absorption and/or NIR reflection and/or NIR scattering.

The term “foil exhibiting low NIR absorption” is used herein. It shall mean an NIR-opaque foil which exhibits an NIR reflection of at least 48% over the entire wavelength range of 780 to 1600 nm and of at least 30% over the entire wavelength range of above 1600 to 2100 nm. The NIR reflection measurement can be carried out as explained above.

The term “front face” is used herein. The front face of the foil provided in step (1) or of the multi-layer composite is the side which is turned towards an observer, whereas the opposite side (back face) is the side which is turned towards a substrate surface when applying the mufti-layer composite to substrates.

The term “coating layer exhibiting low NIR absorption” is used herein. It shall mean a coating layer which would exhibit an NIR reflection of at least 33% over the entire NIR wavelength range of 780 to 2100 nm, if it were applied and dried or cured on an NIR-opaque coating layer pigmented exclusively with aluminum flake pigment. The person skilled in the art may, for example, produce test panels provided with a dried or cured coating layer applied from a coating composition pigmented exclusively with aluminum flake pigment, and may use said test panels as test substrates for coating with coating compositions to be tested for their NIR absorption. Once the coating layer applied from the coating composition to be tested has dried or cured, the NIR reflection of said coating layer can be measured. The NIR reflection measurement itself can be carried out as explained above. The method mentioned in this paragraph can be used by the skilled person when developing the pigmentation of the pigmented coating composition applied in step (2).

The term “NIR-opaque coating layer” is used herein. It refers to a dried or cured pigmented coating layer with a film thickness at least as thick that underlying substrate surfaces (substrate surfaces located directly beneath the coating layer) with different NIR absorption are no longer discernible by NIR reflection measurement, i.e., at or above this minimum dry film thickness no difference can be determined when measuring the NIR reflection of the coating layer applied to such different substrate surfaces and dried or cured; or to put it into other words, the NIR reflection curve measured is then only determined by the NIR-opaque coating layer. In still other words, an NIR- opaque coating layer is characterized in that its dry film thickness corresponds to or exceeds said minimum film thickness, but may not fall below it. It goes without saying that this minimum film thickness depends on the pigmentation of the respective coating layer, i.e., it depends on the composition of the pigment content as well as on the pigment/resin solids weight ratio. In order to determine said minimum film thickness, the respective coating composition may be applied in a wedge shape onto a black and white chart and dried or cured. NIR reflection measurement can be carried out as explained above.

The term “aluminum flake pigments” is used herein. It means aluminum pigments, in particular those of the non-leafing type, as are conventionally used as special effect pigments in paint and coatings to provide a metallic effect, i.e., a brightness flop dependent on the angle of observation. Generally, such aluminum flake pigments are 100 to 1000 nm thick and have a mean particle diameter of, for example, 5 to 50 μm, preferably 5 to 35 μm. The mean particle diameters may be inferred, for example, from the technical documents of manufacturers of such aluminum flake pigments. Examples of such commercially available aluminum flake pigments include those sold by Eckart under the names “STAPA Hydrolac®”, “STAPA Hydrolux®” and “STAPA IL Hydrolan®”. However, aluminum flake pigments with a thinner flake thickness of 10 to 80 nm, preferably 20 to 80 nm, are also meant by the term “aluminum flake pigments” used herein. The 10 to 80 nm thick aluminum flake pigments have an aspect ratio (the ratio of the flake diameter to the flake thickness) that is very high. The 10 to 80 nm thick aluminum flake pigments are produced, for example, by vacuum deposition or ultrathin grinding of special aluminum grits. Generally such thin aluminum flake pigments have a mean particle diameter of, for example, 5 to 30 μm, preferably 5 to 20 μm. The mean particle diameters may be inferred, for example, from the technical documents of manufacturers of such thin aluminum flake pigments. Examples of such thin commercially available aluminum flake pigments include those sold under the names Metalure®, Silvershine® and Hydroshine®, in each case by Eckart, Metasheen® by Ciba, Starbrite® by Silberline and Decomet® by Schlenk.

The term “mean particle diameter” (average particle size) is used herein. It refers to d50 values determined by laser diffraction (50% of the particles have a particle diameter above and 50% of the particles have a particle diameter below the mean particle diameter).

In the description and the claims “cured” or “curing” is used in the context of curing of coatings. To avoid misunderstandings, said use of “cured” or “curing” shall not be interpreted to mean only “chemically crosslinked” or “chemically crosslinking”. Rather, it may also mean “physically dried” or “physically drying”.

The term “pigment content” is used herein. It means the sum of all the pigments contained in a coating composition without fillers (extenders, extender pigments). The term “pigments” is used here as in DIN 55944 and covers, in addition to special effect pigments, inorganic white, colored and black pigments and organic colored and black pigments. At the same time, therefore, DIN 55944 distinguishes between pigments and fillers.

The term “resin solids” is used herein. The resin solids of a coating composition consist of the solids contribution of the coating binders (binder solids) and the solids contribution of crosslinkers (crosslinker solids) optionally contained in the coating composition.

The term “film thickness” is used herein. It refers always to the dry film thickness of the respective dried or cured coating. Accordingly, any film thickness values indicated in the description and in the claims for coating layers refer in each case to dry film thicknesses.

The term “brightness L*” is used herein. It means the brightness L* (according to CIEL*a*b*, DIN 6174), measured on the coated front face of the multi-layer composite at an illumination angle of 45 degrees to the perpendicular (surface normal) and an observation angle of 45 degrees to the specular (specular reflection). Said brightness L* measurement is known to the person skilled in the art and can be carried out with commercial professional measuring instruments, for example, the instrument X-Rite MA 68 sold by the firm X-Rite Incorporated, Grandeville, Mich., USA.

In step (1) of the process of the present invention an NIR-opaque foil exhibiting low NIR absorption (herein also called “foil” for short) is provided. Said foil may be an aluminum foil, a metallized plastic film or a film of pigmented plastic. Examples of metallized plastic films include those which have been metallized by chemical means and those which have been metallized by physical methods like, for example, vapor deposition. Examples of pigmented plastic films are those made from plastic material containing pigments which provide the NIR-opacity, for example, aluminum flake pigments.

In step (2) of the process of the present invention, a coating layer is applied from a pigmented coating composition onto the front face of the NIR-opaque foil exhibiting low NIR absorption provided in step (1).

The pigmented coating composition may be a coating composition comprising no liquid carrier like water and/or organic solvents. However, typically, the pigmented coating composition is a solvent- or waterborne coating composition in which case it contains (i) one or more organic solvents or (ii) water or (iii) water and one or more organic solvents.

In addition to its pigment content and, in case the pigmented coating composition is a solvent- or waterborne coating composition, water and/or organic solvent(s), the pigmented coating composition comprises a resin solids content and the following optional components: fillers and conventional coating additives.

The resin solids of the pigmented coating composition comprise one or more conventional coating binders known to the person skilled in the art. Examples include polyester, polyurethane and (meth)acrylic copolymer resins and also hybrid binders derived from these resin classes. Furthermore the resin solids may comprise one or more crosslinkers and one or more paste resins (grinding resins; resins used for pigment grinding) or polymeric pigment wetting or dispersion aids. If paste resins or polymeric pigment wetting or dispersion aids are comprised they are counted as binders.

The pigmented coating composition comprises a pigment content consisting 50 to 100 wt. % of at least one black pigment with low NIR absorption and 0 to 50 wt. % of at least one further pigment which is selected in such a way that the coating layer applied in step (2) exhibits low NIR absorption and that the multi-layer composite of the present invention exhibits a brightness L* of at most 10 units, wherein the sum of the wt. % equals 100 wt. %. The pigment/resin solids ratio by weight of the pigmented coating composition is, for example, 0.1:1 to 1:1.

A black pigment with low NIR absorption is one which, when pigmenting a coating composition with said black pigment and an aluminum flake pigment in a pigment weight ratio of 10:90 and without using other pigments, results in the NIR reflection of a dried or cured coating layer applied from the coating composition in an NIR-opaque film thickness being at least 33% over the entire wavelength range of 780 to 2100 nm. NIR reflection measurement can be carried out as explained above. Preferred examples of black pigments with low NIR absorption are iron oxide black pigments, mixed metal/iron oxide black pigments, for example, of the inverse spinal type, and, in particular, perylene black pigments. Examples of commercially available perylene black pigments are Paliogen® Black L 0084 and Paliogen® Black L 0086 from BASF.

The pigment content of the pigmented coating composition may consist exclusively of the at least one black pigment with low NIR absorption or it may also comprise above 0 to 50 wt. % of at least one further pigment which is selected in such a way that the coating layer applied in step (2) exhibits low NIR absorption and that the multi-layer composite exhibits a brightness L* of at most 10 units. In other words, the selection of the at least one further pigment is performed in a manner meeting two conditions, namely condition (i) relating to the low NIR absorption of the coating layer and, simultaneously, condition (ii) relating to the brightness L* of the multi-layer composite of at most 10 units.

This means with regard to condition (i): In case there is only one single further pigment its wt. % proportion is selected within said range of above 0 to 50 wt. % such that the coating layer exhibits low NIR absorption; if the one single further pigment is a pigment with strong NIR absorption, the skilled person will select its wt. % proportion more at the lower end of said wt. % range, whereas in case of one single further pigment with low NIR absorption the opposite is possible. In case there is a combination of two or more further pigments with different NIR absorption power the same principles apply and the proportion of each of the further pigments may accordingly be selected within the range of above 0 to 50 wt. %, i.e., taking into account the NIR absorption of each individual further pigment. The person skilled in the art knows how to determine the NIR absorption or NIR absorption power of a pigment. The NIR absorption of a pigment may easily be determined, for example, by pigmenting a coating composition with the pigment in question and aluminum flake pigment in a pigment weight ratio of 10:90, i.e., without using other pigments, by applying and drying or curing the coating composition thus pigmented in an NIR-opaque film thickness, and by measuring the NIR reflection of the resultant coating layer over the entire wavelength range of 780 to 2100 nm. NIR reflection measurement can be carried out as explained above.

At the same time this means with regard to condition (ii): In case there is only one single further pigment its wt. % proportion is selected within said range of above 0 to 50 wt. % such that the multi-layer composite exhibits a brightness L* of at most 10 units; if the one single further pigment has a light color, the skilled person will not select its wt. % proportion at the upper end of said wt. % range, whereas in case of one single further pigment with a dark color this may be possible. In case there is a combination of two or more further pigments with not only different color but also different brightness the same principles apply and the proportion of each of the further pigments may accordingly be selected within the range of above 0 to 50 wt. %, i.e., taking into account the brightness of each individual further pigment.

The further pigment(s) that may optionally be contained in the pigmented coating composition, in addition to the at least one black pigment with low NIR absorption may, for example, be special effect pigments and/or pigments selected from white, colored and other black pigments (black pigments different from the black pigments with low NIR absorption).

Examples of such special effect pigments which may be used in the pigmented coating composition include conventional pigments imparting to a coating a color and/or brightness flop dependent on the angle of observation, such as non-leafing metal pigments, for example, aluminum flake pigments or flake pigments of other metals than aluminum, interference pigments such as, for example, metal oxide-coated metal pigments, for example, iron oxide-coated aluminum, coated mica such as, for example, titanium dioxide-coated mica, iron oxide in flake form, liquid crystal pigments, coated aluminum oxide pigments, and coated silicon dioxide pigments.

Examples of such white, colored and other black pigments which may be used in the pigmented coating composition are conventional inorganic or organic pigments known to the person skilled in the art, such as, for example, titanium dioxide, carbon black, iron oxide pigments different from iron oxide black pigments, azo pigments, phthalocyanine pigments, quinacridone pigments, pyrrolopyrrole pigments, and perylene pigments different from perylene black pigments.

It is preferred that the pigmented coating composition does not contain any carbon black.

The black pigment(s) with low NIR absorption and the further pigments that may optionally be contained in the pigmented coating composition are generally ground with the exception of possible special effect pigments. Grinding is generally performed until at least 70% of the maximum tinting strength achievable in the non-volatile system of the pigmented coating composition is achieved (non-volatile system of the pigmented coating composition means resin solids of the pigmented coating composition plus non-volatile additives of the pigmented coating composition). The determination of the maximum tinting strength is known to the person skilled in the art (compare, for example, DIN 53238). The grinding may be performed in conventional assemblies known to the person skilled in the art. Generally, the grinding takes place in a proportion of the binder or in specific paste resins. The formulation is then completed with the remaining proportion of the binder or of the paste resin.

The possible special effect pigments are not ground. They are typically initially introduced in the form of a commercially available paste, optionally combined with organic solvents and, optionally, polymeric pigment wetting or dispersion aids and/or other additives, and then mixed with the binder(s). Special effect pigments in powder form may first be processed with organic solvents and, optionally, polymeric pigment wetting or dispersion aids and/or other additives to yield a paste.

The pigmented coating composition may also contain one or more fillers, for example, in a total proportion of up to 20 wt. % based on the resin solids. For the fillers the same principles apply as are valid for the at least one further pigment, i.e., if fillers are contained in the pigmented coating composition they are selected in such a way that the coating layer applied in step (2) of the process of the present invention exhibits low NIR absorption. The fillers may have a mean particle diameter of, for example, 20 nm to 3 μm. The fillers do not constitute part of the pigment content of the pigmented coating composition. Examples are barium sulfate, kaolin, talcum, silicon dioxide, layered silicates and any mixtures thereof.

The pigmented coating composition may contain conventional additives in a total quantity of, for example, 0.1 to 5 wt. %, relative to its solids content. Examples are neutralizing agents, antifoaming agents, wetting agents, adhesion promoters, catalysts, leveling agents, anticratering agents, thickeners and light stabilizers, for example, UV absorbers and/or HALS compounds (HALS, hindered amine light stabilizers).

If the pigmented coating composition is a waterborne coating composition, it comprises water in a proportion of, for example, 55 to 90wt. % and, optionally, also one or more organic solvents in a proportion of, for example, 0 to 20 wt. %. If it is a solventborne coating composition, it does not comprise water but one or more organic solvents in a proportion of, for example, 55 to 90 wt. %.

Examples of organic solvents which can be used in the pigmented coating composition include alcohols, for example, propanol, butanol, hexanol; glycol ethers, for example, diethylene glycol di-C1-C6-alkyl ether, dipropylene glycol di-C-C6-alkyl ether, ethoxypropanol, ethylene glycol monobutyl ether; glycol esters, for example, ethylene glycol monobutyl ether acetate; esters, for example, butyl acetate, amyl acetate; glycols, for example, ethylene glycol and/or propylene glycol, and the di- or trimers thereof; N-alkylpyrrolidone, for example, N-ethylpyrrolidone; ketones, for example, methyl ethyl ketone, acetone, cyclohexanone; aromatic or aliphatic hydrocarbons, for example, toluene, xylene or linear or branched aliphatic C6-C12 hydrocarbons.

The overall solids content of the solvent- or waterborne pigmented coating composition is in the range of 10 to 40 wt. %, based on the total composition. Accordingly, the proportion of volatiles (volatile materials) is 60 to 90 wt. %. The volatiles comprise the aqueous or non-aqueous carrier and possible volatile additives. An aqueous carrier comprises water and possible organic solvents, whereas a non-aqueous carrier comprises only organic solvents.

In step (2) of the process of the present invention the pigmented coating composition is applied onto the front face of the NIR-opaque foil exhibiting low NIR absorption. Application of the pigmented coating composition may be performed by various application methods, for example, printing, spray coating or, in particular, roller coating,

The pigmented coating composition may be applied in a relatively thin film thickness to form a transparent or semitransparent coating layer; generally, the film thickness of the (semi)transparent coating layer is in the range of, for example, 4 to 20 μm. It is preferred however, that the pigmented coating composition is applied sufficiently thick so as to form a visually opaque coating layer; then its film thickness corresponds to or exceeds black/white opacity. The dry film thickness of a visually opaque coating layer is higher than that of a (semi)transparent coating layer and lies generally in the range of, for example, 8 to 30 μm.

As already mentioned, the coating layer applied in step (2) may be (semitransparent, and in this case the color of the front face of the multi-layer composite is determined by the color contributions of both, the coating layer and the foil, although in general the coating layer makes the main contribution to the color of the multi-layer composite. If the coating layer applied in step (2) is a visually opaque coating layer, it is the coating layer which determines the color of the multi-layer composite.

The coating layer applied in step (2) is cured. Curing may be performed by application of heat, for example, exposing the foil provided with the coating layer to conditions which enable an object peak temperature in the range of, for example, 60 to 250° C.

In its basic form, the multi-layer composite as product of the process of the present invention is a two-layer composite consisting of the foil and the cured coating layer on its front face. In an embodiment, the multi-layer composite takes the form of said two-layer composite having in addition a colorless clear coat layer as an overcoat on top of the cured coating layer which had been applied from the pigmented coating composition. Such clear coat may be applied on the cured pigmented coating layer and then cured or it may be applied by the wet-on-wet paint application method. The latter method means that the clear coat is applied onto the not yet cured pigmented coating layer and that pigmented coating layer and clear coat layer are then jointly cured. Generally such outer clear coat does not or essentially not contribute to the color of the multi-layer composite. In another embodiment, the multi-layer composite takes the “sandwich” form of said two-layer composite having in addition a colorless transparent plastic film on top of the cured coating layer. Generally such outer transparent plastic film does not or essentially not contribute to the color of the multi-layer composite.

The multi-layer composite produced by the process of the present invention exhibits a dark color in terms of that it exhibits a brightness L* of at most 10 units. Examples of such dark colors are corresponding dark-green, dark-blue, dark-red, dark-brown, dark-grey and black color shades and they include solid colors and special effect colors like metallic and/or mica color shades.

The mufti-layer composite with its front face turned towards the sun heats up only comparatively slightly. The multi-layer composite can therefore be used to provide substrate surfaces with a dark-color covering which heats up only comparatively slightly in sunlight.

The multi-layer composite can be applied to surfaces of various substrates, wherein the substrates may be comprised of one or various materials including, for example, metals and plastics. The substrates may already be provided with a coating or they may be uncoated. Examples of substrates include vehicles including automotive vehicles; housings of apparatuses; buildings and parts thereof including roofs, roof parts, facades and facade elements.

Once applied to a substrate surface the multi-layer composite has several functions including a decorative and a protective function. It provides the substrate with a dark-color surface, with mechanical protection and with protection against influence of the environment including heat protection in terms of preventing strong heating-up in sunlight.

Application of the multi-layer composite is performed with its back face turned towards the substrate surface so that the coated front face of the multi-layer composite is turned towards an observer.

The multi-layer composite can be applied in the form of a set, i.e. it may be used in the form of a number of multi-layer composite pieces cut to fit individual surfaces of a substrate.

Application of the multi-layer composite may be performed by laminating or adhesive bonding, for example. Laminating or adhesive bonding may optionally be promoted by suitable measures, for example, the action of heat and/or vacuum. Adhesive bonding may be achieved by using a hot-melt adhesive, an aqueous dispersion adhesive or a solvent-based adhesive or the multi-layer composite is self-adhesive by means of a pressure sensitive adhesive on its back face.

In an embodiment, the substrate onto which surface the multi-layer composite is applied is a plastic substrate formed by per se known injection molding or reaction-injection molding (RIM). In said embodiment, the application of the multi-layer composite to the surface of a plastic substrate is performed involving said per se known injection molding or reaction-injection molding process. In the course of such molding process the plastic substrate to be covered is not only formed but at the same time covered with the multi-layer composite. Such process comprises putting the multi-layer composite into a mold, for example, a thermoforming mold, injecting a liquid polymeric material into the mold and letting the polymeric material solidify to form the plastic substrate. The plastic substrate may be hollow or not, or it may be a foamed article. The liquid polymeric material can be a thermoplastic material or a liquid mixture of reactive components. During said (reaction-) injection molding process the so-formed plastic substrate and the multi-layer composite are firmly joint with the surface of the plastic substrate adjacent to the back face of the multi-layer composite. After solidification of the polymeric material the mold can be opened and the plastic substrate covered with the dark-color multi-layer composite can be released.

What is claimed is:

1. A process for the production of multi-layer composite comprising the successive steps:
(1) providing an NIR-opaque foil exhibiting low NIR absorption, and
(2) applying a coating layer from a pigmented coating composition onto the front face of the foil,
wherein the pigment content of the coating composition consists 50 to 100 wt. % of at least one black pigment with low NIR absorption and 0 to 50 wt. % of at least one further pigment, which is selected in such a way that the coating layer exhibits low NIR absorption and that the multi-layer composite has a color with a brightness L* of at most 10 units,
wherein the sum of the wt. % equals 100 %, and
wherein the coating layer is cured.

2. The process of claim 1, wherein the NIR-opaque foil exhibiting low NIR absorption is selected from the group consisting of an aluminum foil, a metallized plastic film and a film of pigmented plastic.

3. The process of claim 1, wherein the at least one black pigment with low NIR absorption is selected from the group consisting of iron oxide black pigments, mixed metal/iron oxide black pigments and perylene black pigments.

4. The process of claim 1, wherein the coating composition does not contain any carbon black.

5. The process of claim 1, wherein the coating composition is applied by roller coating.

6. The process of claim 1, wherein the coating layer is a transparent, a semitransparent or a visually opaque coating layer.

7. A multi-layer composite produced by a the process of claim 1 and taking the form of a two-layer composite consisting of the NIR-opaque foil exhibiting low NIR absorption and the cured coating layer on the front face of said foil.

8. The multi-layer composite of claim 7 having a colorless clear coat layer or a colorless transparent plastic film on top of the cured coating layer.

9. Use of the multi-layer composite of claim 7 or 8 for applying it to the surface of a substrate with the back face of the multi-layer composite turned towards the substrate surface.

10. The use of claim 9, wherein the substrate is selected from the group consisting of vehicles, housings of apparatuses, buildings and parts of buildings.

11. The use of claim 9, wherein the substrate is a plastic substrate which is formed by an injection molding or reaction-injection molding process during which process the so-formed plastic substrate and the multi-layer composite are firmly joint with the surface of the plastic substrate adjacent to the back face of the multi-layer composite.
